(19) United States
(12) Patent Application Publication
(10) Pub. No.: US 2023/0242127 A1
(43) Pub. Date: Aug. 3, 2023

(54) VISUAL AND WIRELESS JOINT THREE-DIMENSIONAL MAPPING FOR AUTONOMOUS VEHICLES AND ADVANCED DRIVER ASSISTANCE SYSTEMS

(71) Applicant: GM Global Technology Operations LLC, Detroit, MI (US)

(72) Inventors: Brent Navin Roger Bacchus, Sterling Heights, MI (US); Rakesh Kumar, Mississauga, CA (US); Bo Yu, Troy, MI (US)

(21) Appl. No.: 17/587,706

(22) Filed: Jan. 28, 2022

(51) Int. Cl. B60W 40/105; G06V 20/56; H04W 88/10

(52) U.S. Cl. CPC B60W 40/105; G06V 20/588; H04W 88/10; B60W 2420/52; B60W 2420/42; B60W 2552/53

(57) ABSTRACT

A system to map an outdoor environment includes at least one map including an access point (AP) position map, and a reflector map generated from multiple wireless signals collected by multiple automobile vehicles. A set of crowd-sourced data is collected from individual ones of the multiple automobile vehicles derived from multiple perception sensors when the at least one of the multiple automobile vehicles pass a mapping area. A data package is created from the set of crowd-sourced data including a group of wireless positioning samples and a group of visual features, the data package being forwarded to an On-Cloud database where On-Cloud Mapping is conducted. Multiple range measurements yield circular AP candidate positions within a free-space operating window of vehicle operation of the multiple automobile vehicles. Application of the range measurement plus multiple reflectors defined at multiple planar reflective surfaces improves the AP candidate positions.

### INTRODUCTION

The present disclosure relates to vehicle position mapping systems using wireless technology.

Wireless signals and visual features are used separately for vehicle positioning and mapping. Positioning using wireless signals typically requires wireless infrastructure to be accurately mapped prior to use. Global Positioning System (GPS) operation for vehicles including automobile vehicles such as cars, trucks, vans, sport utility vehicles, autonomously operated vehicles and electrically powered vehicles and the like using wireless signals provides wireless infrastructure but may be negatively impacted by environmental conditions, including buildings, structure, reflective surfaces and the like. A precise location of an automobile vehicle, or pose, is necessary if the vehicle environment contains negative environmental conditions reducing accurate use of wireless signals.

Multipath is also known to degrade performance of a wireless based positioning system. In wireless and radio communication, multipath is a propagation phenomenon that results in signals reaching a receiving antenna by two or more paths. Causes of multipath include atmospheric ducting, ionospheric reflection and refraction, and reflection from water bodies and terrestrial objects such as mountains and buildings. When the same signal is received over more than one path, the multiple signal path receipt may create interference and phase shifting of the received signal and therefore use of the received signal may generate an inaccurate location of an automobile vehicle. Destructive interference causes fading which may cause a wireless signal to become too weak in certain areas to be received adequately.

Thus, while current automobile vehicle positioning systems achieve their intended purpose, there is a need for a new and improved automobile vehicle position mapping system.

### SUMMARY

According to several aspects, a system to map an outdoor environment includes at least one map including an access point (AP) position map identifying positions of multiple APs, and a reflector map generated from multiple visual features and multiple wireless signals collected by multiple automobile vehicles. A set of crowd-sourced data id collected from individual ones of the multiple automobile vehicles derived from multiple perception sensors when the at least one of the multiple automobile vehicles pass a mapping area. A group of wireless positioning measurements include: a time-of-flight, an angle-of-arrival, a channel state information, and power delay profiles. A data package is created from the set of crowd-sourced data including a group of wireless positioning samples and a group of visual features, the data package being forwarded to an On-Cloud database where On-Cloud Mapping is conducted. Multiple range measurements yield circular AP candidate positions within a free-space operating window of vehicle operation of at least one of the multiple automobile vehicles, wherein application of the range measurement plus multiple reflectors defined at multiple planar reflective surfaces improves the AP candidate positions.

In another aspect of the present disclosure, the wireless positioning measurements include: a time-of-flight, an angle-of-arrival, a channel state information, and power delay profiles.

In another aspect of the present disclosure, the perception sensor data collected includes images from one or more cameras, images from one or more laser imaging detection and ranging (lidar) systems, and images from a radar system.

In another aspect of the present disclosure, additional sensor data is collected including data from a GNSS, a vehicle speed, a vehicle yaw, and vehicle CAN bus data.

In another aspect of the present disclosure, the AP position map and the reflector map individually contain candidate locations of access-points (APs) and AP corresponding media-access-control (MAC) identities.

In another aspect of the present disclosure, locations of potential signal reflectors defining surfaces upon which wireless signals may reflect from are identified by the AP position map and the reflector map.

In another aspect of the present disclosure, at least one of the multiple automobile vehicles is equipped with a radio receiver, the radio receiver providing range measurements to different ones of the APs, with the range measurements provided as one of line-of-sight (LOS) or non-line-of-sight (NLOS) measurements.

In another aspect of the present disclosure, the AP position map and the reflector map further contain semantic data identifying walls, buildings or other real-world objects.

In another aspect of the present disclosure, at least one aggregate partial map is created for the individual automobile vehicles and optimized global maps of the wireless APs and the planar surfaces, wherein the AP position map and the reflector map may be further combined with data uploaded from one or more prior automobile vehicle generated maps.

In another aspect of the present disclosure, the On-Cloud Mapping Process includes individual ones of the multiple automobile vehicles' uploaded data, leveraged visual features, and wireless positioning programs applied to create the AP position map and the reflector map.

According to several aspects, a system to map an outdoor environment includes at least one map generated from multiple wireless signals collected by multiple automobile vehicles. An onboard-processing segment of at least one of the multiple automobile vehicles includes a perception sensor data derived from at least one camera, a lidar system or from a radar system and data from a GPS unit. A semantic feature detection module detects lane edges of a roadway. A 3D position detection module detects 3D positions of planar surfaces proximate to the multiple automobile vehicles. An image feature extraction module identifies objects including corners, and descriptors including pixels about a given vehicle location. An output of the image feature extraction module is forwarded to a 3D feature coordinate module which determines 3D feature coordinates via structure from motion of one of the multiple automobile vehicles. A model generator receives an output from the 3D position detection module, the 3D feature coordinate module, together with vehicle sensor data and a range data. An optimizer receives data from the model generator, the optimizer solving for a location of one of the automobile vehicles and any objects identified for input to the at least one map.

In another aspect of the present disclosure, the at least one map includes an access point (AP) position map identifying positions of multiple APs, and a reflector map generated from multiple visual features and multiple wireless signals collected by the multiple automobile vehicles.

In another aspect of the present disclosure, an On-Cloud database is provided where On-Cloud Mapping of the access point (AP) position map and the reflector map are conducted.

In another aspect of the present disclosure, the optimizer defines one of a Kalman filter and a non-linear least squares solver.

In another aspect of the present disclosure, a loop closure detection module recognizes if an object or a surface was previously identified and becomes identified for a second or later time.

In another aspect of the present disclosure, the onboard-processing segment further includes range data derived from an angle of attack (AoA) sensor.

In another aspect of the present disclosure, the onboard-processing segment further includes vehicle sensor data including from odometry information, an inertial-measurement-unit (IMU), a wheel-speed-sensor (WSS), and visual-odometry (VO) data.

According to several aspects, a method to collect data and to map an outdoor environment comprises: applying an individual vehicle's data processing step using one or more cameras or a lidar system to detect reflective surfaces, such as via semantic segmentation; collecting the reflective surfaces as a data set; fitting the reflective surfaces of the data set to planar models; creating one or more access point (AP) maps having estimated AP positions and planar surfaces; developing multiple planar surface maps; combining wireless AP range information with planar surface detections to estimate a true AP position; and applying a particle filter to obtain a spatial distribution of AP positions and an automobile vehicle pose.

In another aspect of the present disclosure, the method further includes extracting visual features, and matching and tracking the visual features for odometry and loop closure.

In another aspect of the present disclosure, the method further includes collecting multiple maps created by multiple automobile vehicles.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic presentation of a system and method for mapping an outdoor environment according to an exemplary aspect;

FIG. 2 is a plan view of a semi-circular candidate source surface for the system of FIG. 1;

FIG. 3 is a plan view modified from FIG. 2 to show a potential AP position;

FIG. 4 is a graph identifying power versus time for first, second and third order reflections;

FIG. 5 is a flow diagram presenting steps for performing per-vehicle processing for the system and method of FIG. 1;

FIG. 6 is a flow diagram presenting steps for aligning multiple vehicle generated maps to create a final map for the system and method of FIG. 1;

FIG. 7 is a flow diagram presenting offline mapping process steps on the cloud;

FIG. 8 is a plan view presenting the mapping process conducted on a single automobile vehicle;

FIG. 9 is a flow diagram presenting the on-cloud mapping process conducted for the system and method of FIG. 1; and

FIG. 10 is a plan view presenting three hypotheses for inferring an AP location.

### DETAILED DESCRIPTION

The following description is merely exemplary in nature and is not intended to limit the present disclosure, application, or uses.

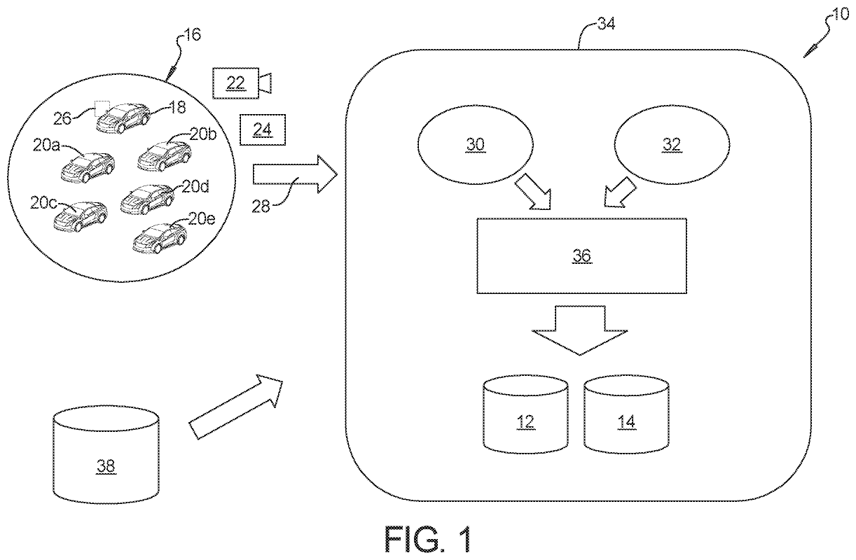

Referring to FIG. 1, a system and method for mapping an outdoor environment 10 uses visual features and wireless signals to generate one or more maps including an access-point (AP) position map 12 and a reflector map 14. A set of crowd-sourced data 16 is initially collected. The crowd-sourced data 16 is collected from multiple individual vehicles including a host automobile vehicle 18 and multiple other vehicles 20a, 20b, 20c, 20d, 20e. The crowd-sourced data 16 is data derived from various perception sensors when the host automobile vehicle 18 and the multiple other vehicles 20a, 20b, 20c, 20d, 20e pass a mapping area which is defined as any area within a travel path of one of the multiple automobile vehicles. Perception sensor data that is collected includes images from one or more cameras 22, images from one or more laser imaging detection and ranging (lidar) systems 24, radar, and the like. Wireless positioning measurements are also collected which include: a vehicle time-of-flight, a vehicle angle-of-arrival, channel state information, power delay profiles, and the like. Other sensor data may also be collected such as vehicle global navigation satellite system (GNSS) data, a vehicle speed, a vehicle yaw, a set of vehicle CAN bus data, and the like.

According to several aspects, at least one of the vehicles including the host automobile vehicle 18 is equipped with a radio receiver 26 such as but not limited to WiFi fine time measurement (FTM), 5G, and the like. An environment which the host automobile vehicle 18 operates in may hinder a global positioning system (GPS) performance and hinder identification of AP positions. The AP position map 12 and the reflector map 14 therefore contain candidate locations of access-points (APs) and their corresponding media-access-control (MAC) IDs. Locations of potential signal reflectors defining surfaces upon which wireless signals may reflect from are identified by the AP position map 12 and the reflector map 14. The AP position map 12 and the reflector map 14 may further contain image features developed from systems such as scale-invariant feature transform (SIFT) and their coordinates. The AP position map 12 and the reflector map 14 further contain other relevant semantic data identifying for example walls, buildings, roadways, intersections and the like. The radio receiver 26 may also provide range measurements to different APs, however multiple ranges may be reported due to the above noted signal reflectors and measurements may be provided as line-of-sight (LOS) or non-line-of-sight (NLOS) measurements as discussed in greater detail in the figures that follow.

A data package 28 is created from the set of crowd-sourced data 16 and includes a group of wireless positioning samples 30 and a group of visual features 32 which is forwarded for example by the radio receiver 26 to an On-Cloud database 34 where an On-Cloud Mapping Process 36 is then conducted. The On-Cloud Mapping Process 36 includes processing individual vehicles' uploaded data, leveraging visual features, algorithms and wireless positioning algorithms jointly to create the AP position map 12 and the reflector map 14. Aggregate partial maps are created for the individual vehicles and create optimized global maps of wireless access points and planar surfaces. The AP position map 12 and the reflector map 14 may be further combined with data uploaded from one or more automobile vehicle generated pre-existing or prior maps 38 created from ground surveys, aerial imagery, and the like.

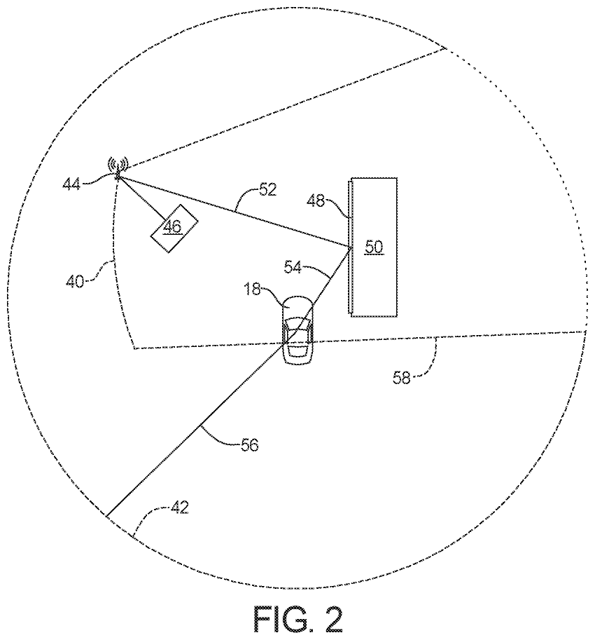

Referring to FIG. 2 and again to FIG. 1, range measurements yield circular candidate positions 40 within a free-space operating window 42 of vehicle operation. A direct line-of sight from for example the host automobile vehicle 18 to a candidate AP 44 may be blocked by an occlusion 46. Using the range measurement plus reflectors defining by multiple planar surfaces such as a reflective surface 48 of a building 50 gives improved AP candidate positions. A first reflective range 52 from the reflective surface 48 to the candidate AP 44 added to or combined with a second reflective range 54 from the host automobile vehicle 18 to the reflective surface 48 together yield a free-space range 56 which defines the free-space operating window 42. Fusing multiple measurements over time further refines the range measurements, for example by triangulation and may include a range with reflection 58. Multiple other items such as a planar surface of a sign, a surface of a stop light, and a visual feature such as a tree, and the like may be identified as reflective surfaces and saved in the AP position map 12 and the reflector map 14.

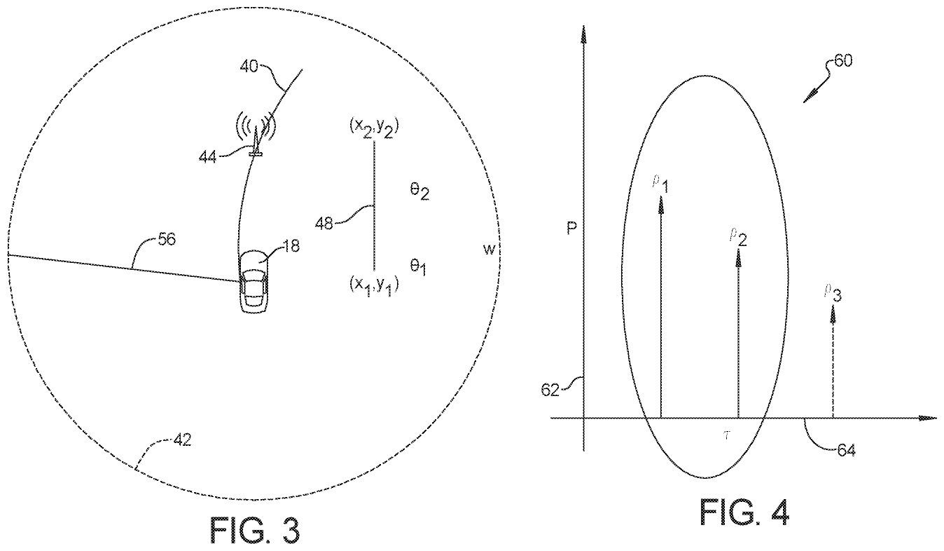

Referring to FIG. 3 and again to FIG. 2, individual ones of the multiple planar surfaces, for example the reflective surfaces creates a semi-circular candidate source surface. The mapping process requires estimating source APs using first-order reflections. Measurement model assumptions are therefore made. The free-space range 56 defines a range (r) measurement for example from a sensor. X and Y coordinates are assigned to identify extents of the reflective surface 48. The curve representing the circular candidate positions 40 provides a range of true accurate locations of the object or candidate AP 44 based on reflection data.

Referring to FIG. 4 and again to FIG. 3 a graph 60 presents a power 62 over a time 64. It is assumed that power in 2^{nd} and higher order reflections is negligible, therefore p₃ values and higher are negligible and are ignored.

With continuing reference to FIGS. 3 and 4, via the power delay profile or other mechanism such as fine time measurements (FTM), the first two significant path lengths and corresponding powers are obtained, where either: (r₁p₁) represents the LOS path length and power and (r₂p₂) represents the first reflection, or, (r₁p₁) represents the first reflection and (r₂p₂) is a high order reflection.

Via perception, planar surfaces are detected which may cause reflections. Possible locations of a transmitter may be determined by defining an equation 1 below:

{χ∈Rⁿ|ψ(χ;p₁,p₂,r)=0} Equation 1:

Equation 1 identifies a set of points that would terminate at the origin after reflecting from a line segment with terminal points p₁ and p₂ after the distance r.

The LOS range model loss is typically L(χ)=(r−|χ|)². The possibility of reflections is considered using an equation 2 below:

L(χ)=ψ(χ;p₁,p₂,r)². Equation 2:

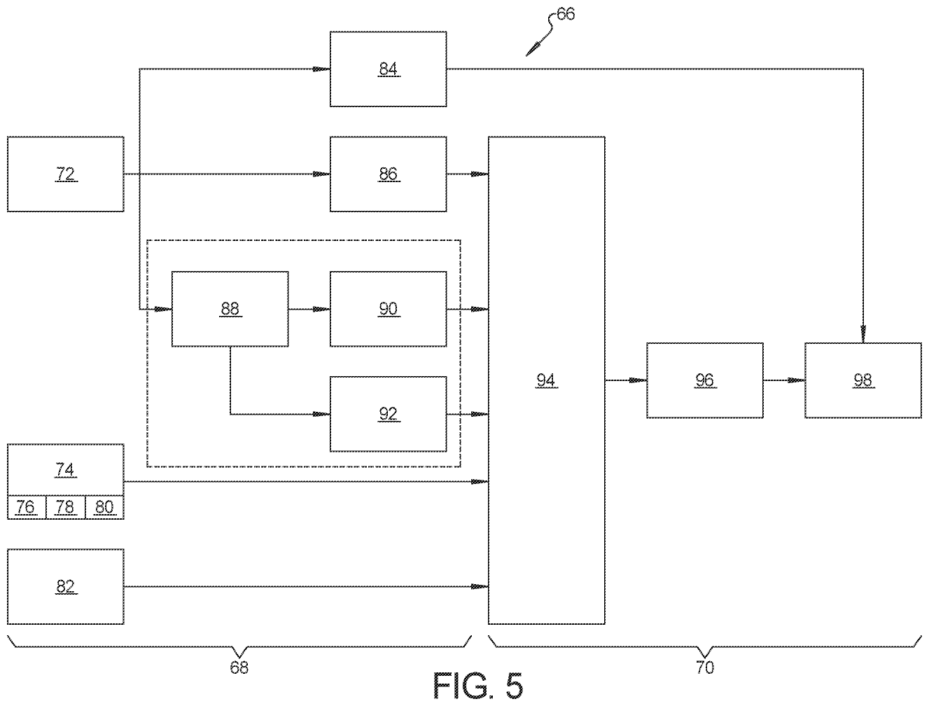

Referring to FIG. 5, a flow diagram 66 identifies how data may be processed in an onboard-processing segment 68 of the individual ones of the automobile vehicles, such as the host automobile vehicle 18 shown in reference to FIG. 1, or in either an onboard-processing or cloud processing 70. The onboard-processing segment 68 includes perception sensor data 72 derived from the one or more cameras 22, the lidar systems 24 or from radar shown in reference to FIG. 1. The onboard-processing segment 68 further includes vehicle sensor data 74 such as from Odometry information, an inertial-measurement-unit (IMU) 76, a wheel-speed-sensor (WSS) 78, visual-odometry (VO) data, and the like; and data from a GPS unit 80. The onboard-processing segment 68 further includes range data 82 derived for example from an angle of attack (AoA) sensor.

The perception sensor data 72 is transferred to several modules including a semantic feature detection module 84 which detects lane edges for example, a 3D position detection module 86 which detects 3D positions of planar surfaces, and an image feature extraction module 88 which performs operations such as scale-invariant feature transform (SIFT) programming to identify objects such as corners, and descriptors such as pixels about a given location, and the like. An output of the image feature extraction module 88 is forwarded to each of a 3D feature coordinate module 90 which determines 3D feature coordinates via structure from motion of for example the host automobile vehicle 18, and a loop closure detection module 92 which recognizes if an object or surface was previously identified and becomes identified for a second or later time.

An output from individual ones of the 3D position detection module 86, the 3D feature coordinate module 90, the loop closure detection module 92, together with the vehicle sensor data 74 and the range data 82 are forwarded to a model generator 94. Data from the model generator 94 is forwarded to an optimizer 96, which may be for example a Kalman filter or a non-linear least squares solver. The optimizer 96 solves for a location of the automobile vehicle such as the host automobile vehicle 18 and any objects identified. An output from the optimizer 96 is forwarded to and generates a vehicle map 98. An output from the semantic feature detection module 84 is forwarded directly to the vehicle map 98 and added to the vehicle map 98 after a vehicle pose is identified. It is noted the model generator 94, the optimizer 96 and the vehicle map 98 may be processed in either the automobile vehicle or in the cloud.

Sensor information used to simultaneously estimate host pose and localizations of various features (SLAM). Semantic segmentation network is trained to identify planar reflective surfaces. Images features are estimated and mapped. Semantic features, for example lane edges, are added to the map after the vehicle pose is learned.

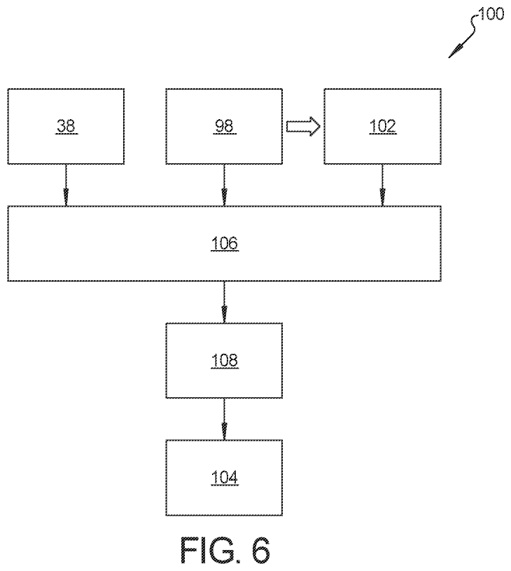

Referring to FIG. 6, a map aggregation flow chart 100 identifies maps built from individual vehicles such as the vehicle map 98 identified in reference to FIG. 5, together with (n) multiple further maps 102 are combined with the data from the prior maps 38 identified in reference to FIG. 1 and saved for example on the cloud to create a final map 104. The prior maps 38 contain more information about connectivity and other missing information. Data from all maps including the vehicle map 98, the multiple further maps 102 and the prior maps 38 are passed through a registration module 106 wherein for example lane edges from all maps can be registered to correct any bias in the positional information of the map features. The registration module 106 line up the map data so all map data from the individual maps is aligned. The aligned maps output from the registration module 106 is then passed into a fusion module 108 which fuses the map data using a weighted average and smooths the data prior to outputting the final map 104.

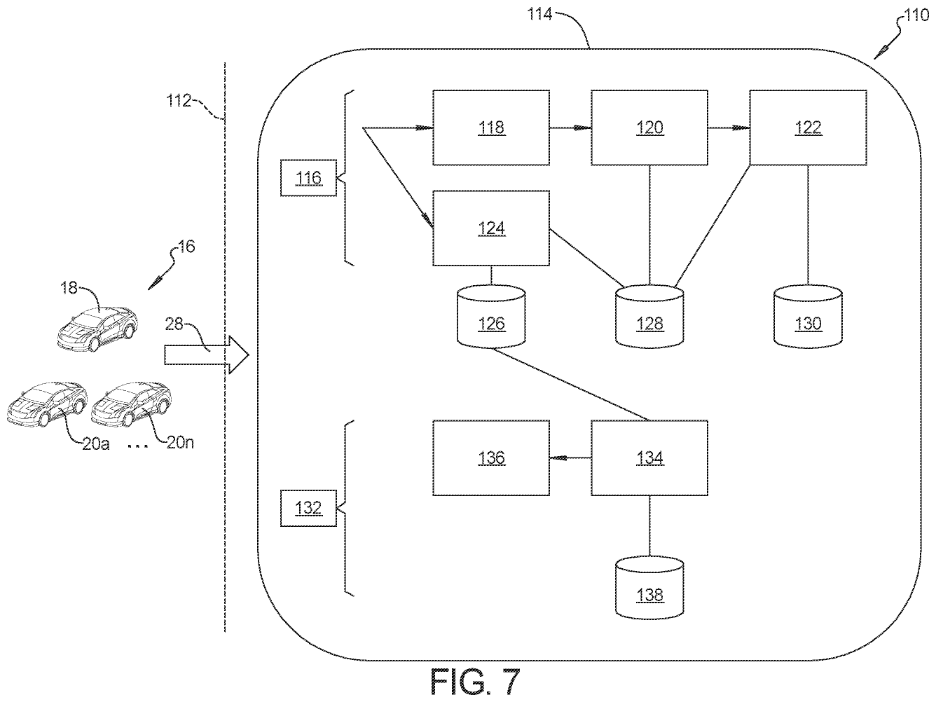

Referring to FIG. 7 and again to FIG. 1, an offline mapping process flow chart 110 identifies multiple processing steps that may be performed on the set of crowd-sourced data 16 uploaded via the data package 28 through a cloud-edge 112 to a cloud processing group 114. A single vehicle uploaded data set 116 may be processed as follows. A sequency of samples of the single vehicle uploaded data set 116 is forwarded to a feature extraction and reconstruction module 118 which extracts data features in the order of the sequency of samples and reconstructs 3D features. Multiple partial point clouds individually produced by the feature extraction and reconstruction module 118 are forwarded to a point cloud registration module 120 which registers and tracks the multiple partial point clouds. An output from the point cloud registration module 120 is directed into a segmentation module 122 which segments identified planar surfaces of the sensed objects. The sequency of samples of the single vehicle uploaded data set 116 is also forwarded in parallel to a sample positioning module 124 which assigns positioning data to images identified. A set of sample positions 126 are output from the sample positioning module 124. A further output of the point cloud registration module 120 is directed to and saved in a global point cloud 128. Data from the global point cloud 128 may be individually forwarded to the sample positioning module 124 and to the segmentation module 122. An output from the segmentation module 122 is used to create a database including multiple planar surface models 130.

In parallel with analyses and processing performed on the single vehicle uploaded data set 116 a crowd sourced AP mapping data set 132 is separately processed. Data from the set of sample positions 126 is forwarded to a particle filter 134 which functions to update and resample data from the set of sample positions 126. A particle filter initialization module 136 receives an output of the particle filter 134 which initializes a next or APn object. A set of AP positions 138 defines a final output of the cloud processing group 114 using an output from the particle filter 134.

It is noted that image processing and the image processing conducted by the feature extraction and reconstruction module 118 may also be performed by one or more of the automobile vehicles in lieu of in the cloud processing group 114. The extracted features and 3D reconstructed image data may then be uploaded together with the data package 28 from the automobile vehicles via the cloud edge 112.

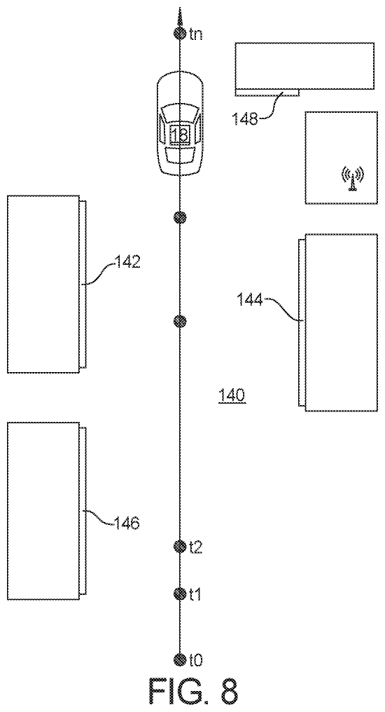

Referring to FIG. 8 and again to FIGS. 1 and 7, an example of the mapping process is as follows. The host automobile vehicle 18 drives through a narrow street 140 defining an urban canyon. The host automobile vehicle 18 collects a sequence of sensor data in a timeline from a time t0 to a time tn. Each frame of data may include a camera image, wireless positioning measurements, GPS data, vehicle speed, yaw, and the like. All of the collected data are uploaded to the cloud such as to the cloud processing group 114 described in reference to FIG. 7 for offline mapping.

For the On-Cloud location there are two mapping processes. A Process 1 defines One Vehicle's Data Preprocessing. The purpose is to process and integrate one vehicle's sensor measurement samples into three (3) databases: a Global Point Cloud database, a Planar Surface database, and a Sample Positions database.

With continuing reference to FIGS. 7 and 8, the feature extraction and reconstruction module 118 loads the sequence of images (or lidar, radar) and leverages 3D reconstruction algorithms such as visual SLAM or Structure From Motion (SFM) to reconstruct the 3D point cloud.

The point cloud registration module 120 uses point registration algorithms to integrate this point cloud into the existing global point cloud data created by other crowd-sourced data.

The segmentation module 122 leverages surface algorithms to identify valid planar surfaces from the point cloud. For example, surfaces 142, 144, 146, 148 are detected. The surfaces 142, 144, 146, 148 are saved into the database including multiple planar surface models 130.

The sample positioning module 124 leverages the camera image from each frame of data to determine a precise position of the vehicle using positioning algorithms from Visual SLAM or SFM. Once the 3D point is determined, the sample positioning module 124 attaches wireless positioning measurement data such as FTM, channel state information (CSI), parallel distributed processing (PDP), and the like to this 3D sample point. Each frame of data from the uploaded sequence is then processed and the created 3D sample points are saved into the database defined by the set of sample positions 126.

These three databases will later be used as input by a Process 2 crowd sourced AP mapping data set 132, which defines a Crowd-sourced AP Mapping process, wherein the particle filter initialization module 136 initializes the particle filter 134 to locate a specific AP (i.e. APx).

The particle filter 134 updates this particle filter data using the wireless position measurement samples from the set of sample positions 126 database. This update process goes through several iterations until a predetermined finish condition is satisfied. Once it finishes, the final position of an APx is saved into the set of AP positions 138 database.

A Particle Weight Calculation is conducted in the particle filter 134. For a Particle gj, the weight is calculated as Equation 3 below:

Equation 3:

$${w}_{j} = {\sum }_{j} {\sum }_{i} {\sum }_{k} PDP ( {q}_{j} , {s}_{i} , {p}_{k} )$$

For Equation 3, gj is one of the particles, si is one of the wireless samples, pk is one of the paths from gj to si. The path can be a direct path (such as p0) or a reflection path (such as p4). PDP(qj,si,pk) is a function which gets the corresponding power level from the wireless measurement for a given path pk between qj and s8.

Since si and gj's positions are known, their direct path or reflection path's length is known. The path length can be converted to time of flight based on the known speed of light. The time-of-flight values can be mapped to the Power Delay Profile generated by the wireless measurement from a position sample.

Features detected by the perception system may optionally be associated with a mapped feature. States include a pose of the automobile vehicle such as the host automobile vehicle 18, coordinates of reflectors in the area of the host automobile vehicle 18, AP positions for individual ones of the hypotheses and image feature locations. A state model is developed based on equations 4 through 8 below:

xₜ₊₁^{host}=xₜ^{host}+Δxₜ^{odom} Equation 4:

ϕₜ₊₁^{host}=ϕₜ^{host}+Δϕₜ^{odom} Equation 5:

pₜ₊₁^{reflector,i}=pₜ^{reflector,i} Equation 6:

pₜ₊₁^{AP,j}=pₜ^{AP,j} Equation 7:

pₜ₊₁^{feat,l}=pₜ^{feat,l} Equation 8:

Observations include: 1) Odometry information, inertial-measurement-unit (IMU) 76, wheel-speed-sensor (WSS) 78, visual-odometry (VO), and the like; 2) Image features; 3) GPS data; 4) Reflector coordinates from perception and 5) Range, MAC address and AoA measurements of APs if available. An observation model is developed based on equations 9 through 12 below:

\tilde{x}^{GPS}=xₜ^{host} Equation 9:

\tilde{p}^{reflector,i}=R(−ϕₜ)(pₜ^{reflector,i}−xₜ^{host}) Equation 10:

\tilde{p}^{feat,l}=R(−ϕₜ)(pₜ^{feat,l}−xₜ^{host}) Equation 11:

ψ(R(−ϕₜ)(pₜ^{AP,j}−xₜ^{host});pₜ^{reflector,i},\tilde{r}ₖ)=0 Equation 12:

With the addition of loop-closure constraints, the system above represents a SLAM problem. Multiple AP locations may be estimated for each measurement as it may be unknown if the source is LOS or NLOS. AP information is associated based on MAC addresses. A solution may be obtained using Kalman filters, particle filters or factor graph optimization.

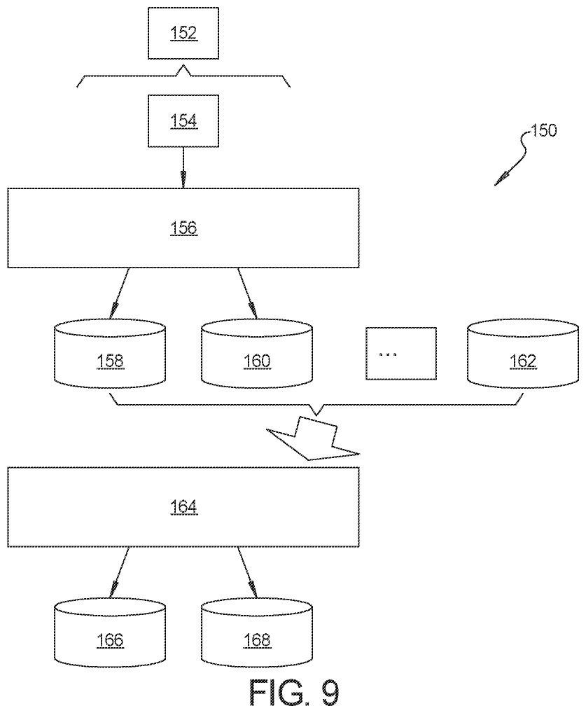

Referring to FIG. 9 and again to FIGS. 1 through 8, a flow diagram 150 provides method steps for conducting the On-Cloud mapping process. For an individual vehicle's data processing step 152, the one or more cameras 22, the lidar system 24, or the like are used to detect reflective surfaces, such as via semantic segmentation, are collected in a sequency of samples collection step 154. The data from the sequency of samples collection step 154 is then fit to planar models in a mapping step 156. Visual features are also extracted, matched and tracked for odometry and loop closure. One or more AP maps having estimated AP positions and planar surfaces is then created in an AP map generation step 158. Multiple planar surface maps are developed in a planar surface map creation step 160. Wireless AP range information is combined with planar surface detections to estimate a true AP position. The particle filter 134 described in reference to FIG. 7 is then used to obtain a spatial distribution of AP positions and a host automobile vehicle pose. In a map collection step 162, maps created by other vehicles are collected.

In a data aggregation step 164 the map data from the AP map generation step 158, the planar surface map creation step 160 and the map collection step 162 are aggregated. Also in the aggregation step 164 aggregate partial maps are created by the data collected from the individual vehicles and are used to create optimized global wireless AP maps 166 of wireless access points and to create global planar surface maps 168. The mapping creation process may occur onboard any of the multiple automobile vehicles including the host automobile vehicle 18 or in the cloud processing group 114 described in reference to FIG. 7.

The following marginal likelihood functions can be defined:

f(y/Hₒ,z,ψ)=P(p₁ is LOS)P(p₂ is NLOS)P(r₁ is LOS)P(r₂ is NLOS)

f(y|H1,z,ψ)=P(p₁ is NLOS)(r₁ is NLOS)P(p₁ is random)P(r₁ is random)

f(y|Ha,z,ψ)=P(y is random)=U(y,a,b)

where:

P(pⱼ is LOS)=N(pⱼ−p(|z|,1,p₀),σ²ₚ)

P(pⱼ is NLOS)=N(pⱼ−p(|z|,α,p₀),σ²ₚ)

P(rⱼ is LOS)=N(rⱼ−|z|,1,σ²ᵣ)

P(rⱼ is NLOS)=1/|L|ΣᵢN(|wᵢ−z|−rⱼ,σ²ᵣ)I(angle(z−wᵢ)∈θᵢ)

### And:

N(x,σ²) is a likelihood of a zero-mean Gaussian with variance σ² at x

U(y,a,b) is a likelihood of a uniform distribution between a and b

|L| is the cardinality of L

(wᵢ, θᵢ)=m(li,x₀,rᵢ)

I(cond) is 1 if cond is true else 0

ψ=(p0, α, σ²ₚ, σ²ᵣ) are nuisance parameters

Given priors P(z), Phi), P(ψ), etc. goal is estimate of the posterior P(z,Hi,ψ/y)

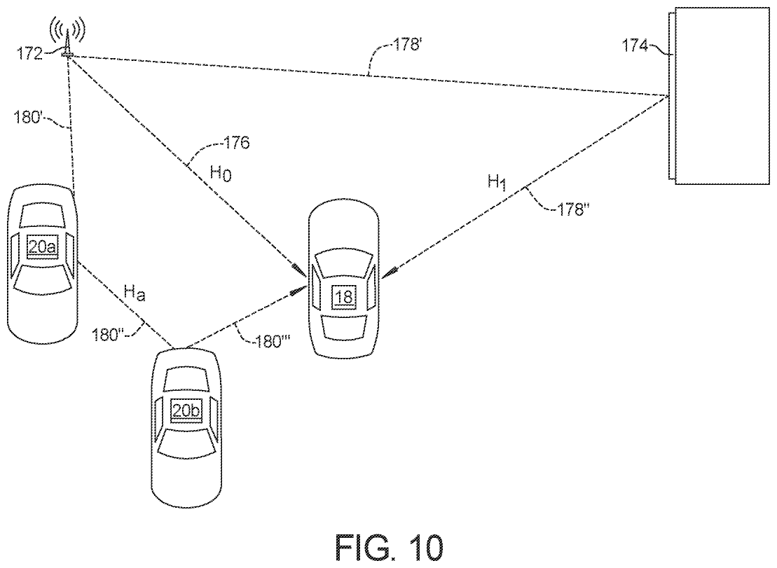

Referring to FIG. 10, measurement model assumptions are provided as follows, given three possible hypotheses considered for an inferred AP location z=(x,y) of an exemplary AP 172 and given the measurement y=(r₁,p₁,r₂,p₂). Three vehicles are shown including the host automobile vehicle 18, the first one of the other vehicles 20a and a second one of the other vehicles 20b. The AP 172 is shown relative to the three vehicles and with respect to an exemplary reflector 174.

Where:

H0 defined by a first line segment 176: z represents the LOS position of the AP.

H1 defined by a second set of line segments 178′, 178″: z represents the first-order reflected position of the AP.

Ha defined by a third set of line segments 180′, 180″, 180′″: z represents a higher order reflection or is from an unknown reflector or is an outlier.

It is assumed that that a receiver power follows an inverse square law p(r,α,p₀)=a (p₀/(r/r₀)² where α=1 for LOS signals, and α<1 for reflections. For mapping, the state space consists of: a host automobile vehicle pose, a planar surface position, the AP 172 position, a reference power is p₀ and a reflection loss is defined by α.

According to a first aspect, the cloud side such as the cloud processing group 114 defined in reference to FIG. 7 creates a crowd-sourced hybrid map based on wireless signals and visual features collected from many vehicles. A low-end vehicle, defined as an automobile vehicle equipped with only wireless radios, can achieve precise positioning using the crowd-sourced hybrid map. The crowd-sourced hybrid map can also be used to correct multipath errors from wireless positioning signals.

According to a second aspect, applying enhanced visual positioning with wireless signals, the cloud side such as the cloud processing group 114 defined in reference to FIG. 7 creates a crowd-sourced hybrid map based on wireless signals and visual features collected from many vehicles. A high-end vehicle, defined as an automobile vehicle equipped with wireless radios and camera/visual features, can leverage the crowd-sourced hybrid map to enhance precise positioning process, including in certain conditions, for example including but not limited to changed lighting conditions, lost tracking of visual features, fast vehicle movement, and the like.

According to a third aspect, when the present system is run using wireless signals plus visual feature positioning on On-Board computing, on one or more individual vehicles; there is no Cloud Computing involved.

According to a fourth aspect, wherein smartphone positioning with wireless signals only is used, positioning may be challenging for the smartphone, especially in urban canyons or multi-floor parking structures. A smartphone can 1) leverage the reflector models and wireless AP models to compensate multipath errors and improve positioning accuracy with wireless signals only; and 2) when a camera on the smartphone is active, the smartphone camera may assist positioning by leveraging the visual features in the point cloud.

The system and method for mapping an outdoor environment 10 of the present disclosure leverages crowd-sourced vehicle sensor data to create maps of wireless access points and maps of reflection surfaces. The system and method for mapping an outdoor environment 10 utilizes visual feature algorithms (e.g. SLAM) to create 3D models of the environments and to extract planar surfaces which may cause multipath reflection. Based on the created planar surfaces, wireless reflection paths are modeled, and wireless AP's precise positions are determined.

The system and method for mapping an outdoor environment 10 of the present disclosure offers several advantages. These include a system that provides for mapping an outdoor environment using a combination of visual features and wireless signals. Multipath sources are identified using visual features from a camera, lidar or other sensors. The maps may be combined with other maps via the cloud and subsequently used by lower tier vehicles (vehicles lacking advanced guidance systems) for functions such as positioning. Visual features are used to identify reflections and dynamic objects in the environment when mapping. Visual features are also used to aid in creation of consistent maps along with wireless measurements.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system to map an outdoor environment, comprising:
at least one map including an access point (AP) position map identifying positions of multiple APs, and a reflector map generated from multiple visual features and multiple wireless signals collected by multiple automobile vehicles;
a set of crowd-sourced data collected from individual ones of the multiple automobile vehicles derived from multiple perception sensors when the at least one of the multiple automobile vehicles pass a mapping area;
a group having wireless positioning measurements;
a data package created from the set of crowd-sourced data including a group of wireless positioning samples and a group of visual features, the data package being forwarded to an On-Cloud database where an On-Cloud Mapping process is conducted; and
multiple range measurements yielding circular AP candidate positions within a free-space operating window of vehicle operation of at least one of the multiple automobile vehicles, wherein application of the multiple range measurements plus multiple reflectors defined at multiple planar reflective surfaces improves the AP candidate positions.

2. The system to map an outdoor environment of claim 1, wherein the wireless positioning measurements include: a time-of-flight, an angle-of-arrival, a channel state information, and power delay profiles.

3. The system to map an outdoor environment of claim 2, wherein the set of crowd-sourced data collected from the multiple perception sensors includes images from one or more cameras, images from one or more laser imaging detection and ranging (lidar) systems, and images from a radar system.

4. The system to map an outdoor environment of claim 3, wherein additional sensor data is collected including data from a GNSS, a vehicle speed, a vehicle yaw, and vehicle CAN bus data.

5. The system to map an outdoor environment of claim 1, wherein the AP position map and the reflector map individually contain candidate locations of access-points (APs) and AP corresponding media-access-control (MAC) identities.

6. The system to map an outdoor environment of claim 1, wherein locations of potential signal reflectors defining surfaces upon which wireless signals may reflect from are identified by the AP position map and the reflector map.

7. The system to map an outdoor environment of claim 1, wherein at least one of the multiple automobile vehicles is equipped with a radio receiver, the radio receiver providing range measurements to different ones of the APs, with the range measurements provided as one of line-of-sight (LOS) or non-line-of-sight (NLOS) measurements.

8. The system to map an outdoor environment of claim 1, wherein the AP position map and the reflector map further contain semantic data identifying roadways and intersections.

9. The system to map an outdoor environment of claim 1, further including at least one aggregate partial map created for the multiple automobile vehicles and optimized global maps of the wireless APs and the multiple planar reflective surfaces, and wherein the AP position map and the reflector map are further combined with data uploaded from one or more prior generated automobile vehicle maps.

10. The system to map an outdoor environment of claim 1, wherein the On-Cloud Mapping Process includes individual ones of data uploaded from the multiple automobile vehicles, leveraged visual features, and wireless positioning programs applied to create the AP position map and the reflector map.

11. A system to map an outdoor environment, comprising:
at least one map generated from multiple wireless signals collected by multiple automobile vehicles;
an onboard-processing segment of at least one of the multiple automobile vehicles including a perception sensor data derived from at least one camera, a lidar system or from a radar system and data from a GPS unit;
a semantic feature detection module detecting lane edges of a roadway;
a 3D position detection module detecting 3D positions of planar surfaces proximate to the multiple automobile vehicles;
an image feature extraction module identifying objects including corners, and descriptors including pixels about a given vehicle location;
an output of the image feature extraction module being forwarded to a 3D feature coordinate module which determines 3D feature coordinates via structure from motion of one of the multiple automobile vehicles;
a model generator receiving an output from the 3D position detection module, the 3D feature coordinate module, together with vehicle sensor data and a range data; and
an optimizer receiving data from the model generator, the optimizer solving for a location of one of the automobile vehicles and any objects identified for input to the at least one map.

12. The system to map an outdoor environment of claim 11, wherein the at least one map includes an access point (AP) position map identifying positions of multiple APs, and a reflector map generated from multiple visual features and multiple wireless signals collected by the multiple automobile vehicles.

13. The system to map an outdoor environment of claim 12, further including an On-Cloud database where On-Cloud Mapping of the access point (AP) position map and the reflector map are conducted.

14. The system to map an outdoor environment of claim 11, wherein the optimizer defines one of a Kalman filter and a non-linear least squares solver.

15. The system to map an outdoor environment of claim 11, further including a loop closure detection module recognizing if an object or a surface was previously identified and becomes identified for a second or later time.

16. The system to map an outdoor environment of claim 11, wherein the onboard-processing segment further includes range data derived from an angle of attack (AoA) sensor.

17. The system to map an outdoor environment of claim 11, wherein the onboard-processing segment further includes vehicle sensor data including from odometry information, an inertial-measurement-unit (IMU), a wheel-speed-sensor (WSS), and visual-odometry (VO) data.

18. A method to map an outdoor environment, comprising:
applying an individual vehicle's data processing step using one or more cameras or a lidar system to detect reflective surfaces, such as via semantic segmentation;
collecting the reflective surfaces as a data set;
fitting the reflective surfaces of the data set to planar models;
creating one or more access point (AP) maps having estimated AP positions and planar surfaces;
developing multiple planar surface maps;
combining wireless AP range information with planar surface detections to estimate a true AP position; and
applying a particle filter to obtain a spatial distribution of AP positions and an automobile vehicle pose.

19. The method of claim 18, further including extracting visual features, and matching and tracking the visual features for odometry and loop closure.

20. The method of claim 18, further including collecting multiple maps created by multiple automobile vehicles.
